(19) United States
(12) Patent Application Publication
(10) Pub. No.: US 2005/0110386 A1
(43) Pub. Date: May 26, 2005

(54) Laser cathode ray tube

(76) Inventors: Michael D. Tiberi, Woodland Hills, CA (US); Bernard K. Vancil, Beaverton, OR (US)

Correspondence Address: LAW OFFICES OF JAMES D. MCFARLAND, 12555 HIGH BLUFF DRIVE, SUITE 305, SAN DIEGO, CA, 92130, US

(21) Appl. No.: 10/981,075

(22) Filed: Nov. 3, 2004

Related U.S. Application Data
(60) Provisional application No. 60/516,771, filed on Nov. 3, 2003.

(51) Int. Cl. H01J 29/46

(52) U.S. Cl. 313/446

(57) ABSTRACT

A Laser-CRT is described in which the laser faceplate is at high potential and the cathode is above ground. The cathodes can be modulated in a dual-drive or push-pull mode in which each of the dual video amplifiers is required to swing only half of the total required voltage, thereby writing smaller pixels faster and achieving higher resolution. Another described embodiment provides a substantially constant laser output over time, and an approximately uniform output intensity over an area. A constant-output Laser-CRT can be used to illuminate a spatial light modulator (SLM) in a projection system, and since video modulation is not required in that embodiment, neither are costly electronics and merely a voltage bias need be applied to the electron gun (e.g., the K electrode) to turn on the electron beam.

### CROSS-REFERENCE TO RELATED APPLICATION

Priority is hereby claimed to U.S. Provisional Patent Application No. 60/516,771, filed Nov. 3, 2003, entitled LASER CATHODE RAY TUBE, which is incorporated by reference herein in its entirety.

### BACKGROUND

1. Field of the Invention

This invention relates to electronic devices, and more particularly to laser cathode ray tubes such as those used in projection televisions or as coherent light sources.

2. Description of Related Art

Conventional cathode ray tubes (CRTs) use phosphors to produce light responsive to an electron beam scanned on the screen containing the phosphors. A conventional CRT includes a funnel-shaped vacuum tube that has a phosphor screen on its wide end. On its narrow end, a conventional CRT has an electron gun including a cathode for generating electrons, a magnetic coil to focus the electrons into a beam, and a deflection coil to deflect and scan the electron beam. In operation, the phosphors on the screen are energized by the scanning electron beam to emit visible light.

Conventional CRTs are widely used for direct-view television and computer monitor applications. Conventional CRTs are also used for projection television; in such systems, the image from a CRT screen is projected onto a screen by projection optics. However, conventional projection CRTs have significant technical restrictions that limit their effectiveness. Although the amount of light produced by conventional CRTs may be somewhat acceptable for images projected over short distances and expanded to small areas (i.e., less than a few square feet), the projected image becomes increasingly dim and eventually becomes unacceptable when projected over increasingly longer distances and spread over larger areas. One reason relates to the divergence of the incoherent light emitted from the screen; incoherent light diverges rather rapidly. Furthermore, phosphors simply cannot produce high luminous flux, lack of which causes a dimly-contrasted projected image, whose limitations become especially apparent over longer projection distances and greater area expansions.

In comparison, a laser cathode ray tube (Laser-CRT) generates very high luminous flux by replacing the phosphor screen with a faceplate that includes a laser cavity, thereby very significantly increasing light output. Since the Laser-CRT outputs coherent light with a small divergence angle, it can easily be projected over long distances and expanded to large areas. Examples of a Laser-CRT are disclosed in U.S. Pat. Nos. 5,254,502; 5,280,360; 5,283,798; 5,313,483; 5,317,583; 5,339,003; 5,374,870; 5,687,185; and in Basov et al., Laser Cathode-Ray Tubes Using Multilayer Heterostructures, Laser Physics Vol. 6 No. 3, 1996, pp. 608-611.

Prior Laser-CRTs typically include a cathode for generating electrons, a magnetic coil to focus the electrons into a beam, a deflection coil to deflect the electron beam to scan the e-beam across screen or location as desired, and a laser cavity comprising a single crystal semiconductor material (e.g., CdS, ZnSe, ZnSSe, CdSSe, and so forth) formed within a faceplate. Because the laser faceplate generates significant heat, a cooling system is needed to cool the faceplate. Often times active cooling is required to dissipate the excess heat, using transparent fluids such as water or alcohol flowing over the faceplate.

In some prior art implementations the cooling fluid comprises a conductive material such as water. Because the laser faceplate is usually connected to a glass tube by a metallic ring and is in direct contact with the cooling fluid, the application of high voltage to the laser faceplate in this configuration would be potentially hazardous. In order to avoid this hazard, the laser faceplate may be grounded thereby also grounding the cooling system. However, if the faceplate is grounded, then a high negative potential (e.g., from −35 kV to −75 kV) must be applied to the cathode. (This is in contrast to a conventional CRT where the faceplate is at a high positive potential, for example +35 kV.) Because the cathode must be kept at very high (although negative) voltage, it must be isolated from the surrounding components. Unfortunately, it can be difficult and costly to isolate the nearby electronics if the cathode is at a high voltage; for example such embodiments may require special (i.e., high cost) electronics in order to drive the cathode.

In another version of a prior art Laser-CRT (U.S. Pat. No. 6,373,179 (the '179 patent)), the laser faceplate is electrically isolated from the cooling system so that high positive voltage can be applied to the anode, and the cathode remains at ground. Because the '179 patent requires that the cathode is to be at ground, the cathode cannot be used for electron beam modulation, and therefore modulation must occur at the electrode nearest the cathode. One disadvantage of this configuration is that it effectively reduces the resolution capability of the imaging device in the following way. In order to achieve maximum brightness and contrast from a Laser-CRT, a single video amplifier must provide a full voltage swing (for example in the range of 50 to 180 volts) to write each pixel. In this regime, the video amplifier is slew rate limited, i.e., the voltage increases linearly with time to the maximum value at a rate limited by the amplifier. Due to these technical restrictions, a standard video amplifier would provide low resolution. In order to provide adequate resolution with a single video amplifier, a special, costly amplifier must be used rather than a standard video amplifier.

### SUMMARY

In one embodiment, a Laser-CRT is described in which the laser faceplate is at high potential, the cathode is above ground, the G1 electrode is below ground, and the cathode is modulated along with the G1 electrode in a dual-drive or push-pull mode to achieve high resolution. A G2 electrode is used to control the current flow of the electron beam. A G3 electrode is used to assist in pre-focusing the electron beam, and also to protect against arcing.

A Laser-CRT described herein comprises a faceplate that includes an active gain layer and opposing reflective surfaces, thereby defining a laser area on the faceplate. A cathode emits an electron beam in a direction toward the faceplate to excite laser action at an incident location on the faceplate, and a G1 electrode and a G2 electrode are situated between the cathode and the laser faceplate. An electrical circuit maintains the faceplate at a high positive potential with respect to ground, and a dual-drive modulation system modulates the cathode and the G1 electrode responsive to a control signal. The dual-drive system modulates the cathode from an upper modulation voltage to ground, and also modulates the G1 electrode from a lower modulation voltage that is below ground to ground.

The cathode, the G1 electrode, and the G2 electrode can have a configuration for high bandwidth modulation. In one embodiment the cathode comprises an impregnated cathode that has a small physical size, and the G1 and G2 electrodes have a low capacitance configuration such as shown in U.S. Pat. No. 4,500,809.

By driving both the G1 electrode and the cathode in opposite directions (a “dual-drive” configuration), each of the dual video amplifiers is required to swing only half of the total required voltage. Therefore complete electron beam turn on (or turn off) can be achieved in half the time that would be consumed by a single amplifier driving only one electrode while the other electrode is held at a fixed voltage such as ground. The increase in speed of the dual-drive method translates to smaller pixels being written faster, providing higher resolution at the screen.

Another embodiment of a Laser-CRT described herein provides a substantially constant laser output over time, and an approximately uniform output intensity over an area. Therefore, high video bandwidth modulation is not required in this embodiment. Such a Laser-CRT can provide a constant light source, which is useful for example in a projection system in which the constant light source illuminates a spatial light modulator (SLM) that is used to modulate the constant light. Examples of a suitable SLM include a digital micro-mirror device (DMD), a grating light valve, and a liquid crystal display (LCD). In this embodiment, the high voltage across the Laser-CRT can be split so that a negative potential is applied to the cathode (e.g., −20 kV) and the anode is at high positive potential (e.g., +20 kV) for a total potential of electrons reaching the faceplate of 40 keV. Since video modulation is not required, neither are costly electronics and merely a voltage bias need be applied to the electron gun (e.g., the K electrode) to turn on the electron beam. The voltage at any of the electrodes of the electron gun can be used to adjust the constant output intensity to the desired quantity.

The Laser-CRT in some embodiments may comprise a faceplate cooling system including a nonconductive fluid coolant, a manifold situated on the faceplate that defines at least one channel for directing the coolant over the faceplate, and a recirculating system arranged to circulate the coolant through the channel, thereby cooling the faceplate. In such embodiments, at least one of the channels is sufficiently narrow to provide a substantially laminar flow over the faceplate.

### BRIEF DESCRIPTION OF THE DRAWINGS

For a more complete understanding of this invention, reference is now made to the following detailed description of the embodiments as illustrated in the accompanying drawing, wherein:

FIG. 1 is a cross-sectional view of a Laser-CRT in one embodiment that includes a modulator for modulating the electron beam;

FIG. 2 is a schematic diagram of a laser projection system that includes a plurality of Laser-CRTs including a first, second, and third Laser-CRT, each of which has a G2 electrode that can be individually controlled;

FIG. 3 is a cross-sectional view of a Laser-CRT in another embodiment for providing an output laser beam that is approximately constant over time and uniform over area; and

FIG. 4 is a schematic view of one example of a projection system that utilizes Laser-CRTs to illuminate SLMS with an output laser beam that is approximately constant over time and uniform over area.

### DETAILED DESCRIPTION

This invention is described in the following description with reference to the Figures, in which like numbers represent the same or similar elements.

A Laser-CRT described herein includes a vacuum tube that has a laser faceplate that emits laser radiation in response to impingement by an electron beam.

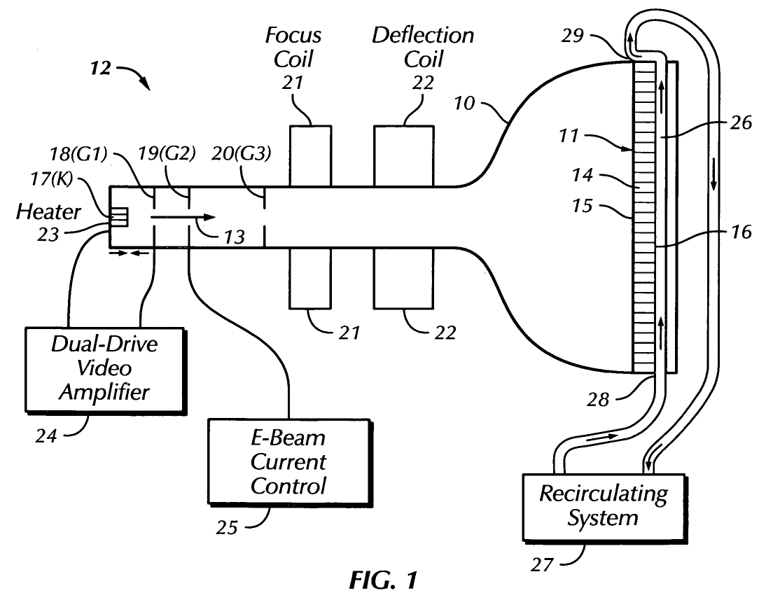

FIG. 1 is a cross-sectional view of a Laser-CRT that includes a funnel-shaped glass envelope 10 that forms the outer surface of a vacuum tube. A laser faceplate 11 is situated on the wide end of the funnel, and the narrow opposite end includes an electron gun apparatus 12 that generates and directs the electron beam 13 to the faceplate. In one embodiment the laser faceplate includes a layer of active gain material 14 situated between two reflective layers (including one fully reflective layer 15 and one partially reflective layer 16) to define a laser cavity area. Since the laser area is typically homogeneous across the faceplate, laser action is created at the point on the faceplate wherever an e-beam with sufficient intensity is incident. Pixels are defined by the target of the electron beam on the faceplate; particularly, the area at which the electron beam is incident becomes a pixel. In some embodiments a “screen mask” could be positioned proximate to the faceplate to define the pixels by allowing the e-beam to pass through only the defined gaps in the mask. The laser. screen may be manufactured by any suitable process, such as that disclosed in co-pending application U.S. Ser. No. 10/364,167, Pub. No. US-2003-0151348-A1 entitled “Method for Making Faceplate for Laser Cathode Ray Tube,” assigned to the same assignee as herein, which is incorporated by reference herein in its entirety.

In one embodiment, the electron gun 12 of the Laser-CRT includes the following grids for controlling the electron beam: a K electrode 17 (i.e., a cathode), a G1 electrode 18, a G2 electrode 19, and a G3 electrode 20. The electron gun also includes a focus coil 21 arranged to assist in focusing the beam to a small spot size, and a deflection coil 22 arranged to deflect the electron beam to the desired screen location in response to the applied video signal from any suitable video source (not shown).

The cathode 17 comprises any suitable configuration, such as an impregnated dispenser cathode, which generates a high electron current density; that is, it can be pushed to higher loading than conventional cathodes. The cathode has a relatively small physical size to provide a low capacitance configuration. In combination these features provide higher video bandwidth and higher loading, which ultimately provides a brighter spot at the screen. A suitable heater 23 is connected to the cathode to generate electrons.

In one embodiment the G1 and/or G2 electrodes comprise a low capacitance configuration, such as disclosed in U.S. Pat. No. 4,500,809, issued Feb. 19, 1985 entitled ELECTRON GUN HAVING A LOW CAPACITANCE CATHODE AND GRID ASSEMBLY, incorporated by reference herein, which advantageously allows very high frequency modulation and increases video bandwidth. Some low capacitance electrodes are termed Ultra High Resolution (UHR) electrodes.

The G1 electrode 18 is spaced apart from the cathode 17 by a short distance, such as 0.003″ to about 0.004″. The space between the G1 electrode and the cathode determines the cutoff voltage, as will be described. Thus, in alternative embodiments, by varying the spacing (e.g., from about 0.002″ to about 0.010″) different cutoff voltages can be obtained.

A dual-drive video amplifier 24 is connected to the K and G1 electrodes to modulate the K and the G1 electrodes. Particularly, the K and G1 electrodes are modulated differentially with the dual-drive video amplifier. Advantageously, this dual-drive configuration offers higher resolution than a single video drive because the depth of modulation of the video signal is twice that of the single drive in one-half the time. For example in one embodiment the dual-drive amplifier modulates the K electrode with +75V to 0V, and the G1 electrode is modulated with −75V to 0V. Thus in that embodiment the “swing” of the tube for a video signal is about 150 volts (from −75 to +75), with a cut-off voltage equivalent or close to the swing. In alternative embodiments, other implementations may utilize different voltage swings.

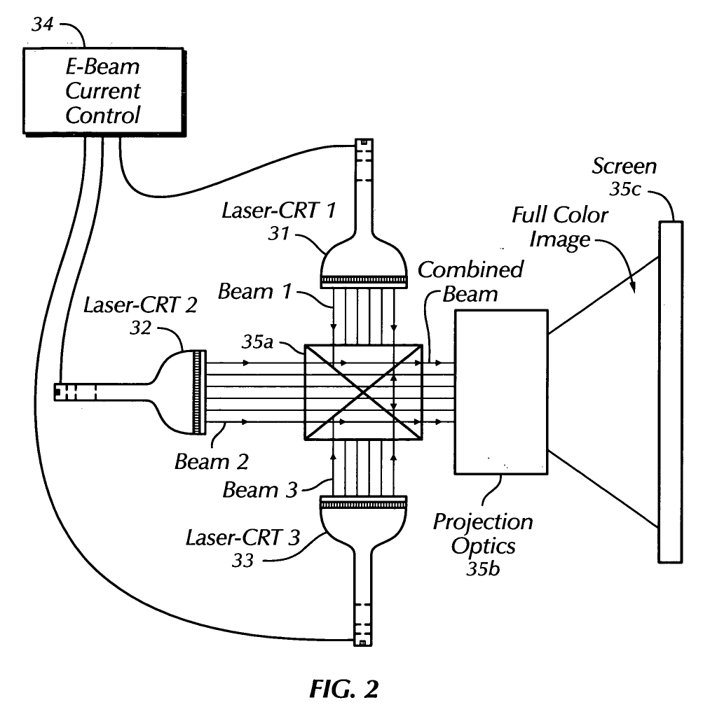

In some embodiments the G2 electrode 19 comprises a low capacitance configuration. The G2 electrode is connected to an e-beam current control system 25, and is typically set at a fixed value during operation to control current from the cathode. For example, the G2 electrode is typically set at a value within a range of about 1000 to 2000 volts. Because the electron current determines the brightness of the screen, the voltage applied to the G2 electrode determines the overall brightness of the screen. Thus, it may be useful in some circumstances, such as shown and discussed with reference to FIG. 2, to vary the electron current using the G2 electrode.

The G3 electrode 20, which may also comprise a low capacitance configuration, is set at a higher voltage than the G2 electrode (for example a fixed value of about 5000 volts). The G3 electrode operates in conjunction with the magnetic focusing coil to pre-focus the electron beam. Furthermore, the G3 electrode operates to protect the electron tube against arcing.

Advantageously, the arrangement of the G3 electrode with the focus coil provides a small spot size (e.g., less than 25 microns) at the faceplate. By reducing the spot size, the amount of current necessary to exceed the laser threshold is correspondingly reduced. Particularly, the laser threshold is that pumping level at which laser action begins. At a lower pumping level, no significant lasing action can occur. The laser threshold is a function of the electron beam current over the spot area; therefore a smaller spot size advantageously reduces the electron current required to attain a desired brightness level, thereby reducing the electron current that must be supplied by the electron gun.

Furthermore in an alternative embodiment the high voltages can be “split”; that is, instead of applying a positive high voltage to the anode (e.g., +40 kV) and maintaining the cathode at ground or slightly above ground, a high negative voltage is applied to the cathode (e.g., −20 kV) and a high positive voltage may be applied to the anode (e.g., +20 kV) providing a total voltage potential of 40 keV to electrons reaching the faceplate. Since the electrodes at the cathode are not being modulated, a constant voltage can be applied to the cathode providing the current necessary to energize the faceplate and produce laser light. Expensive electronics at the cathode would therefore not be required.

The cooling system for the faceplate comprises a manifold 26 situated on the outer surface of the faceplate 11. The manifold defines one more channels through which a coolant flows over the faceplate. A recirculating system 27, which may include a heat exchange system to cool the coolant, is connected to an inlet 28 on the manifold to supply coolant to the manifold. The manifold distributes coolant over the faceplate, cooling the faceplate and in the process warming the coolant. The warmed coolant exits from an outlet 29 of the manifold and is received by the recirculating system, which cools the coolant and re-supplies the now-cooled coolant to the manifold.

Cooling fluids used to dissipate heat from the faceplate must be chosen carefully. If the faceplate is at high positive potential (such disclosed in U.S. Pat. No. 6,373,179), and if the cooling fluid is conductive or if the cooling fluid is potentially explosive (such as alcohol), then the cooling fluid must be electrically isolated from the faceplate.

The cooling system described herein utilizes a transparent, nonconductive cooling fluid to cool the faceplate. Because the coolant is nonconductive, the cooling system is inherently isolated from the high voltage, and no special electrical isolation system is required. One example of a nonconductive cooling fluid is a dielectric cooling fluid such as Fluorinert™ manufactured by 3M™. Of course other perfluorinated fluids, or other nonconductive fluids could also be used.

In one embodiment, the cooling system includes a thin manifold formed over a two-inch laser faceplate to constrain the flow of Fluorinert™ cooling fluid within at least one channel across the laser faceplate. In some embodiments, the manifold provides one or more narrow channels for fluid flow (e.g., 0.5 mm or less), thereby providing a laminar cooling fluid flow across the faceplate. Furthermore, to provide effective cooling, the manifold distributes the cooling fluid over the entire area of the laser faceplate that can be excited by the electron beam.

FIG. 2 is a schematic diagram of one example of a configuration in which adjusting the e-beam current can be advantageous. FIG. 2 shows a plurality of Laser-CRTs including a first, Laser-CRT 31, a second Laser-CRT 32, and a third Laser-CRT 33, each of which has a G2 electrode (shown in FIG. 1) that can be individually controlled by an e-beam current control system 34. The beams from the Laser-CRTs are combined in a. suitable beam combiner 35a such an x-prism shown in FIG. 2, and then projected by suitable projection optics 35b onto a screen 35c. One example of such a real-world system is a projection system in which the three Laser-CRTs respectively provide a red image, a green image and a blue image that are combined and then projected onto a screen to provide a full-color image. In order to properly balance the color combination to provide a desired color balance, each of the G2 electrodes can be individually adjusted via the control system. This adjustment could be accomplished for example manually such as by a user who individually manipulates the controls for each Laser-CRT, or automatically by using sensors as feedback into the current control system that then controls the individual CRTs to provide the desired color balance.

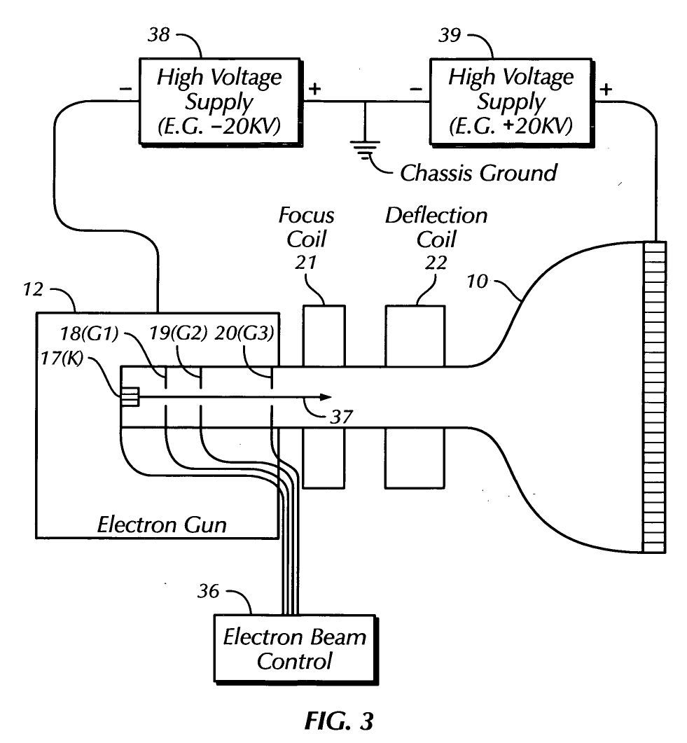

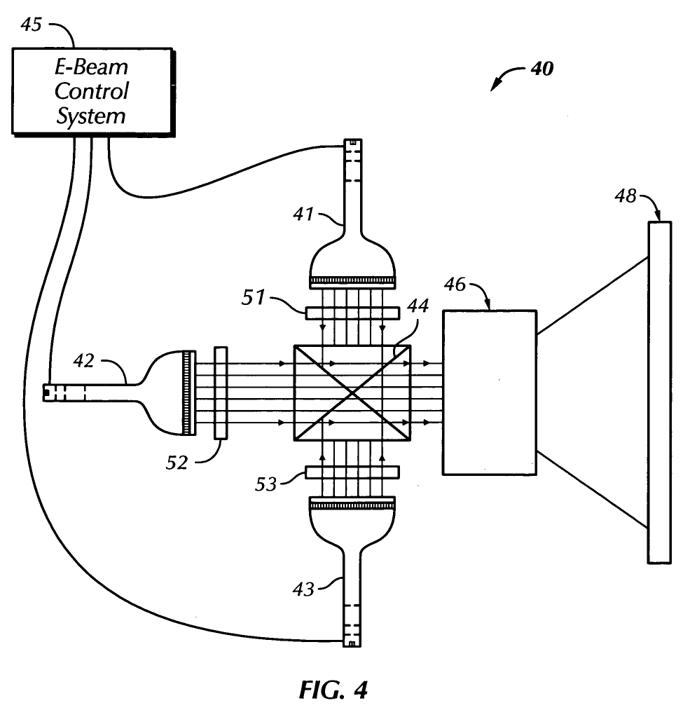

Reference is now made to FIGS. 3 and 4. Another use of a Laser-CRT is that of providing an area laser light source for a spatial light modulator (SLM) such as a liquid crystal, digital micro-mirror, or a grating light valve. SLMs require illumination that is substantially constant over time and uniform over area, and the Laser-CRT described herein is designed to provide such a light source. In one embodiment, one or more Laser-CRTs could replace the lamp conventionally used to illuminate the image-creating device. Since the Laser-CRT is not actually creating the image but rather producing an approximately constant light output that is modulated by SLMs to provide the video image, the Laser-CRT would not require high resolution video amplifiers connected to the cathode, because the electron beam is not being rapidly modulated to produce images.

FIG. 3 is a cross-sectional view of a Laser-CRT for providing constant illumination, area light source. The Laser-CRT in FIG. 3 may have a similar structure to the Laser-CRT shown in FIG. 1, while allowing for design differences related to the differing uses. The Laser-CRT includes the funnel-shaped glass envelope 10 for the vacuum tube, the laser faceplate 11 on the wide end of the funnel, and the electron gun 12 at the narrow end. The electron gun 12 includes a cathode K 17 for emitting electrons and one or more other electrodes, such as the G1, G2, and G3 electrodes described with respect to FIG. 1. The electron beam is scanned across the screen by appropriate magnetic coils such as the deflection coil 22 and the focus coil 21.

An electron beam control system 36 is provided that controls the cathode K and the electrodes in the electron gun to generate an approximately constant electron current flow 37 in an amount that creates the desired output laser intensity from the lasers scanned in the faceplate. Because it is not necessary to rapidly modulate the electron current in this embodiment, no special modulators are required; therefore the electron beam control system and the electron gun may be simplified and less costly than the Laser-CRT shown in FIG. 1. However, the electron beam control system should be adjustable in order to adjust the voltages on the electrodes that control the electron current as appropriate. For example, in order to properly adjust the output to provide the desired output intensity, the voltages on the cathode, G1 and G2 electrodes can be individually adjusted via the control system. This adjustment could be accomplished for example manually such as by a user who individually manipulates the controls for each Laser-CRT, or automatically by using sensors as feedback into the current control system that then controls the individual CRTs to provide the desired intensity.

A high voltage (e.g., 40 kV) is applied between the faceplate and the electron gun. In the embodiment shown in FIG. 3, the high voltage applied between. the faceplate and the electron gun is “split” between two power supplies: a negative voltage supply 38 and a positive voltage supply 39; in other words, instead of applying a positive high voltage to the anode (e.g., +40 kV) from a single voltage supply, and maintaining the cathode at ground or slightly above ground, a high negative voltage is applied to the cathode (e.g., −20 kV) from the high negative voltage supply 38, and a high positive voltage is applied to the anode (e.g., +20 kV) from the high positive voltage supply 39, providing a total voltage potential of about 40 keV to the electrons impinging upon the faceplate. The interconnection between the two voltage sources is at chassis ground.

In one example, the faceplate as the anode is at +20 kV. At the other end of the tube where the electron gun resides, four electrodes control the electron beam, all of which are “floating” at a negative potential:

1) The K electrode (cathode) is the electrode to which −20 kV is applied with respect to tube ground. The −20 kV voltage at the K electrode defines the electron gun's ground.

2) The G1 electrode is adjustable and controls the current or intensity. The G1 electrode goes from −120V to 0 volts with respect to K. −120 V is known as the tube “cut-off” which is the voltage at which are no electrons being emitted when that voltage is applied to G1.

3) The G2 electrode is set to about +1200V with respect to K and controls the electron emission relative to G1.

4) The G3 electrode is a pre-focus electrode and is about +5000V with respect to K.

Therefore, to control the intensity or amount of current then G1 is modulated but K is maintained at −20 kV, which defines ground for the electron gun.

Many variations are possible. The high voltage source can supply any value at either end of the tube as long as the total voltage potential meets design requirements. The electrodes in the electron gun can be at any voltage as well as long as the design requirements are met. One could also put the faceplate at −20 kV and the gun-end at +20 kV.

Since the electrodes at the cathode are not being modulated at high speed in the embodiment described with reference to FIG. 3, an approximately constant voltage can be applied to the cathode providing the current necessary to energize the faceplate and produce laser light. Expensive modulation electronics at the cathode would therefore not be required, and advantageously could be eliminated.

A cooling system such as shown in FIG. 1 (not shown in FIG. 3), could be implemented in the embodiment of FIG. 3. In such an embodiment the cooling system may comprises a manifold situated on the outer surface of the faceplate that defines one more channels through which a coolant flows over the faceplate. A recirculating system, which may include a heat exchange system to cool the coolant, is connected to an inlet on the manifold to supply coolant to the manifold. The manifold distributes coolant over the faceplate, cooling the faceplate and in the process warming the coolant. The warmed coolant exits from an outlet of the manifold and is received by the recirculating system, which cools the coolant and re-supplies the now-cooled coolant to the manifold.

FIG. 4 is a schematic diagram of one example of a projection system 40 that modulates the constant illumination light supplied from the Laser-CRTs of FIG. 3. FIG. 4 shows a plurality of Laser-CRTs including a first Laser-CRT 41, a second Laser-CRT 42, and a third Laser-CRT 43. The intensity of each of the Laser-CRTs can be individually adjusted by an e-beam current control system 45 connected thereto. The beams from the Laser-CRTs are modulated by SLMs (as described below) and then the modulated beams are combined in a suitable beam combiner 44 such as an x-prism and then projected by suitable projection optics 46 onto a screen 48.

One example of such a real-world system is a projection system in which the output of the red, green, and blue Laser-CRTs are individually modulated to respectively provide a red image, a green image and a blue image that are combined and then projected onto a screen to provide a full-color image. In order to properly balance the color combination to provide a desired color balance, each of the Laser-CRTs can be individually adjusted via the control system. This adjustment could be accomplished for example manually such as by a user who individually manipulates the controls for each Laser-CRT, or automatically by using sensors as feedback into the current control system that then controls the individual CRTs to provide the desired color balance.

In one embodiment the projection system may be implemented using a spatial light modulator (SLM) situated in each beam path. Each SLM operates by individually modulating the pixels defined by the SLM. Any suitable SLM will suffice; for example the SLM may be a transmissive SLM such as a liquid crystal panel, or it may be a reflective SLM such as a grating light valve (GLV) or a digital micro-mirror device (DMD). For purposes of illustration, FIG. 4 shows a transmissive SLM; it should be clear that the principle of SLM modulation applies to all types of SLMs.

In the embodiment shown in FIG. 4, a first SLM 51 is arranged in the beam path from the first Laser-CRT 41, a second SLM 52 is arranged in the beam path from the second Laser-CRT 42, and a third SLM 53 is arranged in the beam path from the third Laser-CRT 43. A suitable SLM control circuit (not shown) is connected to each SLM. Each pixel of the SLM is individually modulated responsive to image data, and therefore the Laser-CRTs are used primarily as a constant illumination source. Accordingly, the e-beam control system 45 in that embodiment would control the Laser-CRTs to provide an apparently constant light source from each pixel. Furthermore, scanning the Laser-CRTs may be synchronized with the modulation of the SLM pixels, so as to illuminate the pixels of SLMs in synchronization with their modulation.

It is believed that a Laser-CRT-based projection system described herein can be effectively implemented in grating light valve projectors, and other projection display devices. It is also believed that such a projection system can be manufactured at a practical cost to consumers. For example, the Laser-CRT, either individually or with an SLM, may also be utilized for other applications, such as optical switches, optical routers, and medical lasers.

It will be appreciated by those skilled in the art, in view of these teachings, that alternative embodiments may be implemented without deviating from the spirit or scope of the invention. This invention is to be limited only by the following claims, which include all such embodiments and modifications when viewed in conjunction with the above specification and accompanying drawings.

1. A Laser-CRT comprising:
a faceplate that includes an active gain layer and opposing reflective surfaces, thereby defining a laser area on said faceplate;
a cathode that emits an electron beam in a direction toward the faceplate to excite laser action at an incident location on the faceplate;
a G1 electrode situated between the cathode and the laser faceplate;
an electrical circuit that maintains the faceplate at a high positive potential with respect to ground; and
a dual-drive modulation system that modulates the cathode and the G1 electrode responsive to a control signal, said dual-drive system modulating the cathode from an upper modulation voltage to ground, and modulating the G1 electrode from a lower modulation voltage that is below ground to ground.

2. The Laser-CRT of claim 1 wherein said cathode comprises an impregnated cathode.

3. The Laser-CRT of claim 1 wherein said G1 electrode comprises a low capacitance configuration.

4. The Laser-CRT of claim 1 further comprising a G2 electrode situated between the cathode and the laser faceplate, wherein said G2 electrode comprises a low capacitance configuration.

5. The Laser-CRT of claim 1 wherein the gap between said cathode and said G1 electrode is in the range of about 0.003 and 0.004 inches.

6. The Laser-CRT of claim 1 further comprising:
a G2 electrode situated between the cathode and the laser faceplate,
a G3 electrode situated between said G2 electrode and said faceplate; and
means for controlling said G3 electrode to pre-focus said electron beam on said faceplate.

7. The Laser-CRT of claim 1 and further comprising a faceplate cooling system including:
a nonconductive fluid coolant;
a manifold situated on said faceplate that defines at least one channel for directing said coolant over said faceplate; and
a recirculating system arranged to circulate said coolant through said channel, thereby cooling said faceplate.

8. The Laser-CRT of claim 7 wherein at least one of said channels is sufficiently narrow to provide a substantially laminar flow over the faceplate.

9. A laser projection system comprising:
a plurality of Laser-CRTs, each having an electron gun for controlling the electron current;
a projection system optically coupled to receive the light from the Laser-CRTs, combine the light, and project the combined beam onto a screen to form an image;
an electron beam current control system connected to the electron gun on each of said Laser-CRTS to individually control the electron beam current from each Laser-CRT, thereby providing a system to balance color in the projected image.

10. The laser projection system of claim 9 wherein said projection system comprises:
projection optics; and
a beam combiner optically coupled to receive the output from said Laser-CRTs and provide it to said projection optics.

11. The laser projection system of claim 9 further comprising a dual-drive video modulator connected to modulate the electron gun to provide a video image.

12. The laser projection system of claim 9 wherein each Laser-CRT is configured to provide a laser output that is substantially constant in time and approximately uniform in area, and further comprising a plurality of spatial light modulators, each Laser-CRT being arranged to illuminate one of said spatial light modulators, each spatial light modulator being modulated to provide a video image.

13. A Laser-CRT comprising:
a vacuum tube;
a faceplate on said vacuum tube that includes an active gain layer and opposing reflective surfaces, thereby defining a laser area on said faceplate;
a electron gun in said vacuum tube opposite said faceplate, said electron gun including
a cathode that emits an electron beam in a direction toward the faceplate to excite laser action at an incident location on the faceplate;
a G1 electrode and a G2 electrode situated between the cathode and the laser faceplate;
a positive high voltage source and a negative high voltage source connected in series between the faceplate and the electron gun, wherein the interconnection between said high voltage sources is at ground.

14. The Laser-CRT of claim 13 wherein said first and second high voltage sources provide approximately equal voltages.

15. The Laser-CRT of claim 13 wherein said electron gun further comprises:
a G3 electrode situated between said G2 electrode and said faceplate; and
means for controlling said G3 electrode to pre-focus said electron beam on said faceplate.

16. The Laser-CRT of claim 13 further comprising a faceplate cooling system including:
a nonconductive fluid coolant;
a manifold situated on said faceplate that defines at least one channel for directing said coolant over said faceplate; and
a recirculating system arranged to circulate said coolant through said channel, thereby cooling said faceplate.

17. The Laser-CRT of claim 16 wherein at least one of said channels is sufficiently narrow to provide a substantially laminar flow over the faceplate.
